(19) United States
(12) Patent Application Publication
(10) Pub. No.: US 2005/0027062 A1
(43) Pub. Date: Feb. 3, 2005

(54) Elastomeric composition

(76) Inventors: Walter Harvey Waddell, Pasadena, TX (US); Donald Sheley Tracey, Kingwood, TX (US); Glenn Edward Jones, Kingwood, TX (US)

Correspondence Address: EXXONMOBIL CHEMICAL COMPANY, P O BOX 2149, BAYTOWN, TX, 77522-2149, US

(21) Appl. No.: 10/633,001

(22) Filed: Aug. 1, 2003

(51) Int. Cl. C08K 3/04; C08K 3/34

(52) U.S. Cl. 524/496; 524/495; 524/445

(57) ABSTRACT

This invention provides for a composition including an elastomer having at least 30 mol % of isobutylene; carbon black having a surface area of less than 30 m²/g and a dibutylphthalate oil absorption of less than 80 cm³/100 gm; and polybutene oil having a number average molecular weight greater than 400.

### FIELD OF THE INVENTION

The present invention is directed towards a low-permeability elastomeric composition, and more particularly to a composition comprising an elastomer comprising at least 30 mole % isobutylene, carbon black having a surface area of 30 m²/g or less and a dibutylphthalate oil absorption of 80 cm³/100 gm or less with polybutene processing oil to form an air barrier such as a tire innerliner.

### BACKGROUND

Bromobutyl and chlorobutyl rubbers are the polymers of choice for air-retention in tubeless tires. Similarly, brominated poly(isobutylene-co-p-methylstyrene) (BIMS), such as disclosed in U.S. Pat. Nos. 5,162,445 and 5,698,640, is typically used when heat resistance or another important property is of importance. The selection of ingredients for the commercial formulations of elastomers depends upon the balance of properties desired and the application and end use. For example, in the tire industry, processing properties of the green (uncured) compound in the tire plant versus in-service performance of the cured rubber tire composite, and the nature of the tire, i.e. bias versus radial tire, and passenger versus truck versus aircraft tire are all important considerations that must be balanced.

Polybutene and paraffinic-type processing oils have been disclosed in U.S. Pat. No. 4,279,284 to Spadone, U.S. Pat No. 5,964,969 to Sandstrom et al. and EP 0 314 416 to Mohammed. A paraffinic-type processing oil is disclosed in U.S. Pat. No. 5,631,316 to Costemalle et al. Also, WO 94/01295 to Gursky et al. discloses the use of petroleum waxes and naphthenic oils and resins in a rubber composition for tire sidewalls, and U.S. Ser. No. 09/691,764, filed Oct. 18, 2000 (assigned to the assignee of the present invention) to Waddell et al. discloses colorable rubber compositions. Other disclosures of processing oil or resin-containing elastomeric or adhesive compositions include U.S. Pat. Nos. 5,005,625, 5,013,793, 5,162,409, 5,178,702, 5,234,987, 5,234,987, 5,242,727, 5,397,832, 5,733,621, 5,755,899, EP 0 682 071 A1, EP 0376 558B1, WO 92/16587, and JP11005874, JP05179068A and JO3028244.

WO 02/48257 discloses elastomeric compositions comprising at least one random copolymer comprising a C₄ to C₇ isomonoolefin derived unit, at least one filler, and polybutene oil having a number average molecular weight greater than 400 that are reported to improve processability of elastomeric compositions useful for tires, air barriers, etc, while maintaining or improving the air impermeability of those compositions.

### SUMMARY OF THE INVENTION

This invention relates to a composition comprising:
1) an elastomer comprising at least 30 mol % of isobutylene;
2) carbon black having a surface area of less than 30 m²/g and a dibutylphthalate oil absorption of less than 80 cm³/100 gm, and
3) polybutene oil having a number average molecular weight greater than 400.

### BRIEF DESCRIPTION OF THE FIGS.

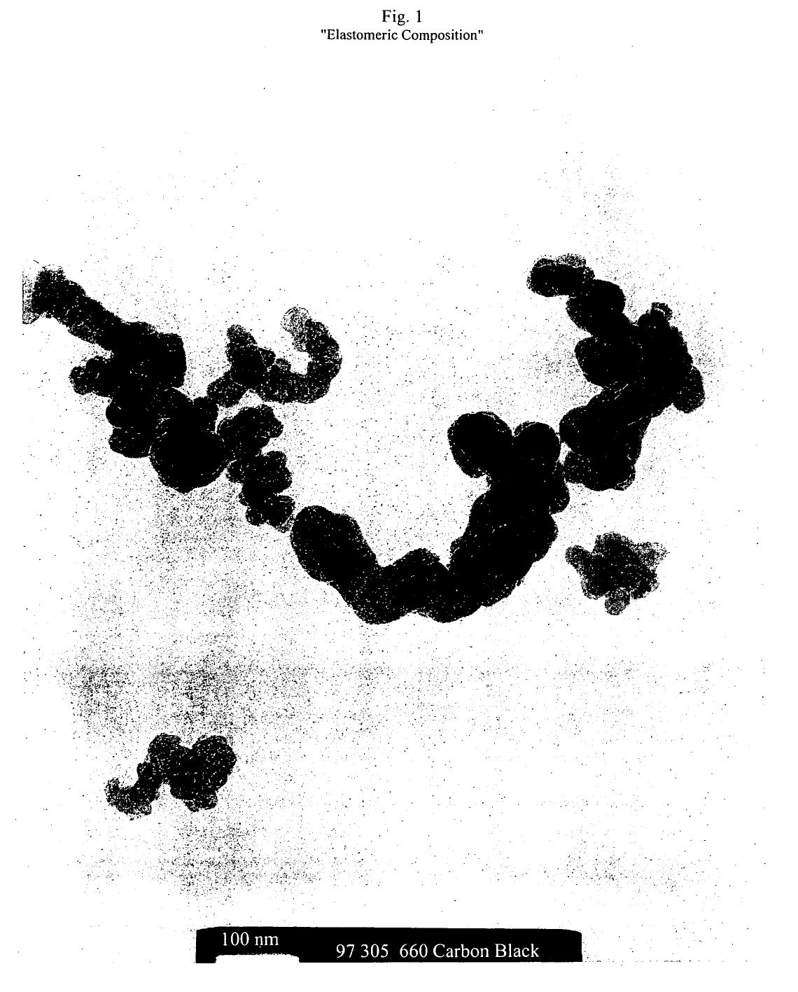

FIG. 1 is a transmission electron micrograph of carbon black N660.

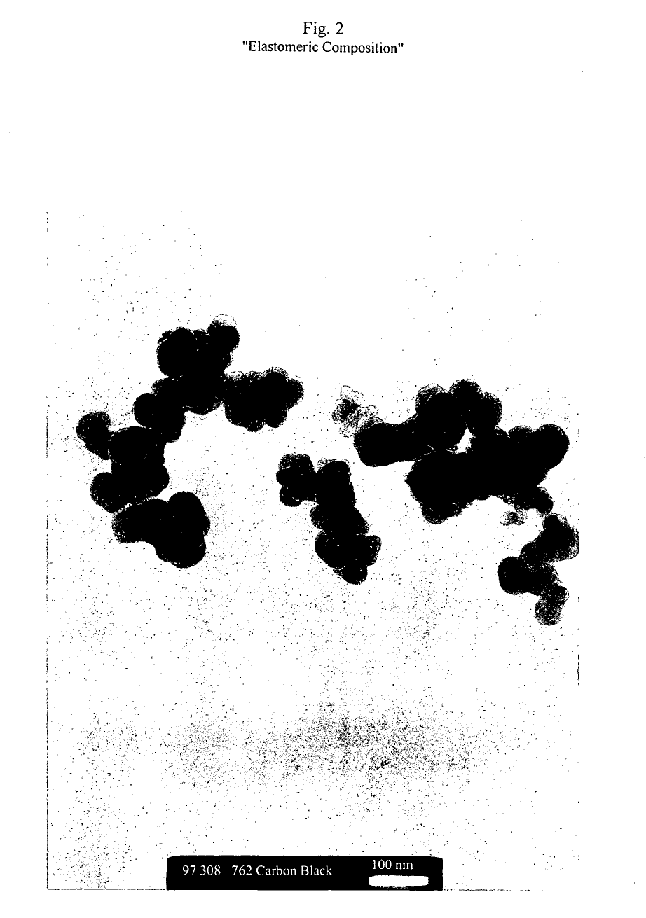

FIG. 2 is a transmission electron micrograph of carbon black N762.

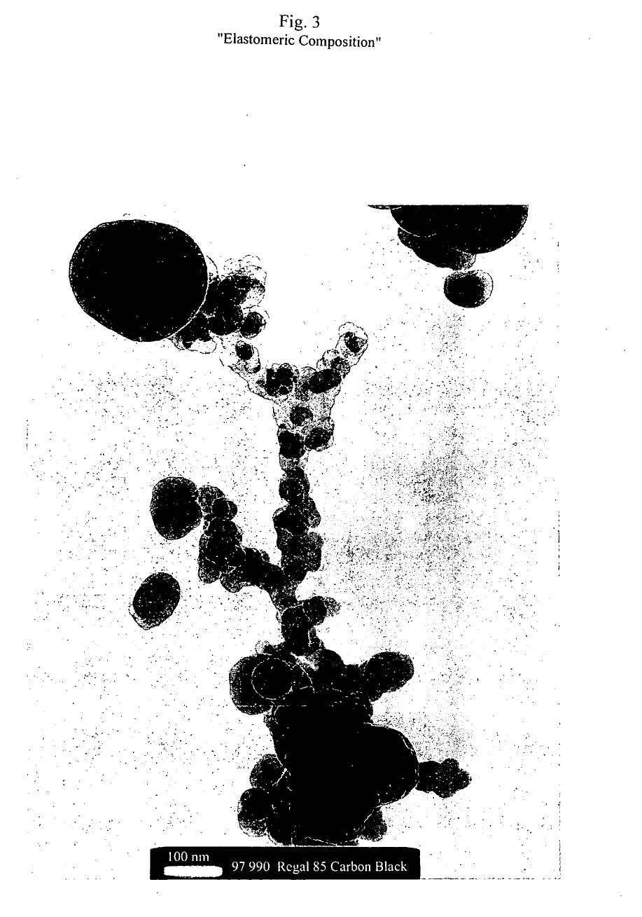

FIG. 3 is a transmission electron micrograph of carbon black Regal 85.

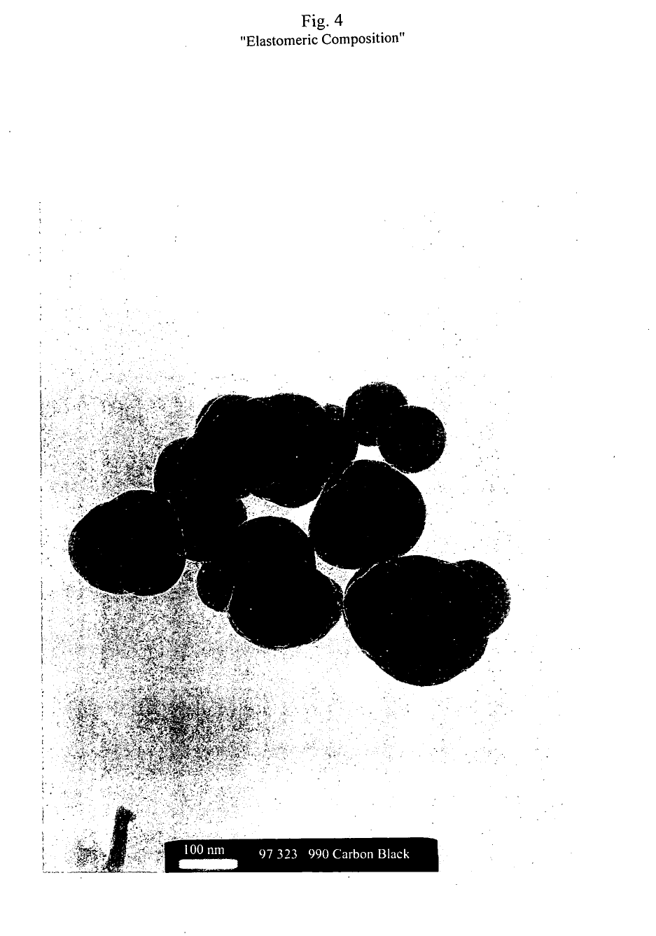

FIG. 4 is a transmission electron micrograph of carbon black N990.

### DEFINITIONS

The term “phr” is parts per hundred rubber, and is a measure common in the art wherein components of a composition are measured relative to a major elastomer component, based upon 100 parts by weight of the elastomer or elastomers.

As used herein, in reference to Periodic Table “Groups”, the new numbering scheme for the Periodic Table Groups are used as in HAWLEY'S CONDENSED CHEMICAL DICTIONARY 852 (13th ed. 1997).

The term “elastomer”, as used herein, refers to any polymer or composition of polymers consistent with the ASTM D1566 definition. The term “elastomer” may be used interchangeably with the term “rubber”, as used herein.

For the purposes of this invention and the claims thereto when a polymer is referred to as comprising an olefin, the olefin present in the polymer is the polymerized form of the olefin.

### DETAILED DESCRIPTION OF THE INVENTION

This invention relates to a composition comprising:
1) an elastomer comprising at least 30 mol % of isobutylene, preferably at least 40 mol % isobutylene, more preferably 50 mol % isobutylene;
2) carbon black having a surface area of less than 30 m²/g; preferably less than 25 m²/g, and a dibutylphthalate (DBP) oil absorption of less than 80 cm³/100 gm, preferably a DBP oil absorption of less than 75 cm³/100 gm, preferably a DBP oil absorption of less than 70 cm³/100 gm, preferably a DBP oil absorption of less than 65 cm³/100 gm; and
3) polybutene oil having a number average molecular weight greater than 400, preferably between 400 and 15, 000, more preferably between 700 and 8000, more preferably between 900 and 6000.

In a preferred embodiment the elastomer is present at 20 to 100 phr, preferably 50 to 100 phr, more preferably 70 to 100 phr, more preferably 80 to 100 phr; and the carbon black having a surface area of less than 30 m²/g; preferably less than 25 m²/g, and a dibutylphthalate (DBP) oil absorption of less than 80 cm³/100 gm is present at 10 to 200 phr, preferably 20 to 180 phr, more preferably 30 to 160 phr, more preferably 40 to 140 phr; and the polybutene oil is present at 2 to 40 phr, preferably 2 to 30 phr, more preferably 2 to 20 phr, more preferably 2 to 15 phr.

Elastomer

In a preferred embodiment the elastomer is selected from poly(isobutylene-co-alkylstyrene), preferably poly(isobutylene-co-p-methylstyrene), halogenated poly(isobutylene-co-alkylstyrene), preferably halogenated poly(isobutylene-co-p-methylstyrene), star branched butyl rubber, halogenated star-branched butyl rubber, butyl rubber, halogenated butyl rubber, and mixtures thereof. In another preferred embodiment the elastomer comprises bromobutyl rubber and or chlorobutyl rubber.

Preferred elastomers useful in the practice of this invention include isobutylene-based homopolymers or copolymers. These polymers can be described as random copolymer of a C₄ to C₇ isomonoolefin derived unit, such as isobutylene derived unit, and at least one other polymerizable unit. The isobutylene-based copolymer may or may not be halogenated.

In one embodiment of the invention, elastomer is a butyl-type rubber or branched butyl-type rubber, especially halogenated versions of these elastomers. Useful elastomers are unsaturated butyl rubbers such as homopolymers and copolymers of olefins or isoolefins and multiolefins, or homopolymers of multiolefins. These and other types of elastomers suitable for the invention are well known and are described in RUBBER TECHNOLOGY 209-581 (Maurice Morton ed., Chapman & Hall 1995), THE VANDERBILT RUBBER HANDBOOK 105-122 (Robert F. Ohm ed., R. T. Vanderbilt Co., Inc. 1990), and Edward Kresge and H. C. Wang in 8 KIRK-OTHMER ENCYCLOPEDIA OF CHEMICAL TECHNOLOGY 934-955 (John Wiley & Sons, Inc. 4th ed. 1993). Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer.

Butyl rubbers are prepared by reacting a mixture of monomers, the mixture having at least (1) a C₄ to C₁₂ isoolefin monomer component such as isobutylene with (2) a multiolefin, monomer component. The isoolefin is in a range from 70 to 99.5 wt % by weight of the total monomer mixture in one embodiment, and 85 to 99.5 wt % in another embodiment. The multiolefin component is present in the monomer mixture from 30 to 0.5 wt % in one embodiment, and from 15 to 0.5 wt % in another embodiment. In yet another embodiment, from 8 to 0.5 wt % of the monomer mixture is multiolefin.

The isoolefin is a C₄ to C₁₂ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, and other monomers such as disclosed in EP 0 279 456 and U.S. Pat. Nos. 5,506,316 and 5,162,425. Other polymerizable monomers such as styrene and dichlorostyrene are also suitable for homopolymerization or copolymerization in butyl rubbers. One embodiment of the butyl rubber polymer of the invention is obtained by reacting 95 to 99.5 wt % of isobutylene with 0.5 to 8 wt % isoprene, or from 0.5 wt % to 5.0 wt % isoprene in yet another embodiment. Butyl rubbers and methods of their production are described in detail in, for example, U.S. Pat. Nos. 2,356,128, 3,968,076, 4,474,924, 4,068,051 and 5,532,312.

A commercial example of a desirable butyl rubber is EXXON™ BUTYL Grades of poly(isobutylene-co-isoprene), having a Mooney viscosity of from 32±3 to 51±5 (ML 1+8 at 125° C.). Another commercial example of a desirable butyl-type rubber is VISTANEX™ polyisobutylene rubber having a molecular weight viscosity average of from 0.9±0.15 to 2.11±0.23×10⁶.

Another embodiment of the butyl rubber useful in the invention is a branched or “star-branched” butyl rubber. These rubbers are described in, for example, EP 0 678 529 B1, U.S. Pat. Nos. 5,182,333 and 5,071,913. In one embodiment, the star-branched butyl rubber (“SBB”) is a composition of a butyl rubber, either halogenated or not, and a polydiene or block copolymer, either halogenated or not. The invention is not limited by the method of forming the SBB. The polydienes/block copolymer, or branching agents (hereinafter “polydienes”), are typically cationically reactive and are present during the polymerization of the butyl or halogenated butyl rubber, or can be blended with the butyl rubber to form the SBB. The branching agent or polydiene can be any suitable branching agent, and the invention is not limited to the type of polydiene used to make the SBB.

In one embodiment, the SBB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber (EPDM), ethylene-propylene rubber (EPM), styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the SBB of the present invention is SB Butyl 4266 (ExxonMobil Chemical Company, Houston Tex.), having a Mooney viscosity (ML 1+8 at 125° C., ASTM D 1646) of from 34 to 44. Further, cure characteristics of SB Butyl 4266 are as follows: MH is 69±6 dN·m, ML is 11.5±4.5 dN·m (ASTM D2084).

The elastomers useful in this invention may be halogenated. Preferred halogenated rubbers include bromobutyl rubber, chlorobutyl rubber, brominated copolymers of isobutylene and para-methylstyrene, brominated copolymers of isobutylene and para-methylstyrene, and mixtures thereof. Halogenated butyl rubber is produced by the halogenation of the butyl rubber product described above. Halogenation can be carried out by any means, and the invention is not herein limited by the halogenation process. Methods of halogenating polymers such as butyl polymers are disclosed in U.S. Pat. Nos. 2,631,984, 3,099,644, 4,554,326, 4,681,921, 4,650,831, 4,384,072, 4,513,116 and 5,681,901. In one embodiment, the butyl rubber is halogenated in hexane diluent at from 4 to 60° C. using bromine (Br₂) or chlorine (Cl₂) as the halogenation agent. The halogenated butyl rubber has a Mooney Viscosity of from 20 to 70 (ML 1+8 at 125° C.) in one embodiment, and from 25 to 55 in another embodiment. The halogen wt % is from 0.1 to 10 wt % based in on the weight of the halogenated butyl rubber in one embodiment, and from 0.5 to 5 wt % in another embodiment. In yet another embodiment, the halogen wt % of the halogenated butyl rubber is from 1 to 2.5 wt %.

A commercial embodiment of the halogenated butyl rubber of the present invention is Bromobutyl 2222 (ExxonMobil Chemical Company). Its Mooney Viscosity is from 27 to 37 (ML 1+8 at 125° C., ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084). Another commercial embodiment of the halogenated butyl rubber is Bromobutyl 2255 (ExxonMobil Chemical Company). Its Mooney Viscosity is from 41 to 51 (ML 1+8 at 125° C., ASTM D1646), and the bromine content is from 1.8 to 2.2 wt %. Further, cure characteristics of Bromobutyl 2255 are as follows: MH is from 34 to 48 dN·m, ML is from 11 to 21 dN·m (ASTM D2084).

In another embodiment of the invention, the elastomer comprises a branched or “star-branched” halogenated butyl rubber. In one embodiment, the halogenated star-branched butyl rubber (“HSBB”) is a composition of a butyl rubber, either halogenated or not, and a polydiene or block copolymer, either halogenated or not. The halogenation process is described in detail in U.S. Pat. Nos. 4,074,035; 5,071,913; 5,286,804; 5,182,333; and 6,228,978. The invention is not limited by the method of forming the HSBB. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the HSBB. The branching agent or polydiene can be any suitable branching agent, and the invention is not limited to the type of polydiene used to make the HSBB.

In one embodiment, the HSBB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the HSBB of the present invention is Bromobutyl 6222 (ExxonMobil Chemical Company), having a Mooney Viscosity (ML 1+8 at 125° C., ASTM D1646) of from 27 to 37, and a bromine content of from 2.2 to 2.6 wt % relative to the HSBB. Further, cure characteristics of Bromobutyl 6222 are as follows: MH is from 24 to 38 dN·m, ML is from 6 to 16 dN·m (ASTM D2084).

Another embodiment of the elastomer useful in the invention is an isoolefin copolymer comprising a halomethylstyrene derived unit. The elastomer in one embodiment of the invention is a random copolymer of comprising at least C₄ to C₇ isoolefin derived units, such as isobutylene derived units, and halomethylstyrene derived units. The halomethylstyrene unit may be an ortho-, meta-, or para-alkyl-substituted styrene unit. In one embodiment, the halomethylstyrene derived unit is a p-halomethylstyrene containing at least 80%, more preferably at least 90% by weight of the para-isomer. The “halo” group can be any halogen, desirably chlorine or bromine. The halogenated elastomer may also include functionalized interpolymers wherein at least some of the alkyl substituents groups present in the styrene monomer units contain benzylic halogen or some other functional group described further below. These interpolymers are herein referred to as “isoolefin copolymers comprising a halomethylstyrene derived unit” or simply “isoolefin copolymer”.

The isoolefin copolymer may also include other monomer derived units. The isoolefin of the copolymer may be a C₄ to C₁₂ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The copolymer may also further comprise multiolefin derived units. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, and other monomers such as disclosed in EP 0 279 456 and U.S. Pat. Nos. 5,506,316 and 5,162,425. Desirable styrenic monomer derived units that may comprise the copolymer include styrene, methylstyrene, chlorostyrene, methoxystyrene, indene and indene derivatives, and combinations thereof

In another embodiment of the invention, the elastomer is a random elastomeric copolymer of an ethylene derived unit or a C₃ to C₆ α-olefin derived unit and an halomethylstyrene derived unit, preferably p-halomethylstyrene containing at least 80%, more preferably at least 90% by weight of the para-isomer and also include functionalized interpolymers wherein at least some of the alkyl substituents groups present in the styrene monomer units contain benzylic halogen or some other functional group.

Preferred isoolefin copolymers useful as elastomers herein may be characterized as interpolymers containing the following monomer units randomly spaced along the polymer chain: 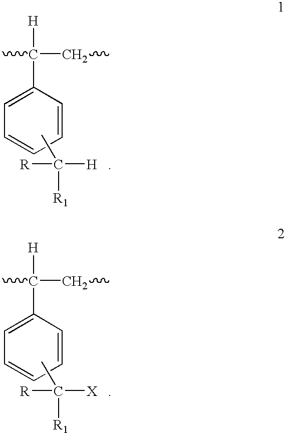
wherein R and R¹ are independently hydrogen, lower alkyl, preferably C₁ to C₇ alkyl and primary or secondary alkyl halides and X is a functional group such as halogen. Desirable halogens are chlorine, bromine or combinations thereof. Preferably R and R¹ are each hydrogen. The —CRR₁H and —CRR₁X groups can be substituted on the styrene ring in either the ortho, meta, or para positions, preferably para. Up to 60 mole % of the p-substituted styrene present in the interpolymer structure may be the functionalized structure (2) above in one embodiment, and in another embodiment from 0.1 to 5 mol % . In yet another embodiment, the amount of functionalized structure (2) is from 0.4 to 1 mol %.

The functional group X may be halogen or some other functional group which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. These functionalized isomonoolefin copolymers, their method of preparation, methods of functionalization, and cure are more particularly disclosed in U.S. Pat. No. 5,162,445.

Most useful of such functionalized materials are elastomeric random interpolymers of isobutylene and alkylstyrene, preferably p-methylstyrene, containing from 0.5 to 20 mole % alkylstyrene, preferably p-methylstyrene, wherein up to 60 mole % of the methyl substituent groups present on the benzyl ring contain a bromine or chlorine atom, preferably a bromine atom (p-bromomethylstyrene), as well as acid or ester functionalized versions thereof wherein the halogen atom has been displaced by maleic anhydride or by acrylic or methacrylic acid functionality. These interpolymers are termed “halogenated poly(isobutylene-co-p-methylstyrene)” or “brominated poly(isobutylene-co-p-methylstyrene)”, and are commercially available under the name EXXPRO™ Elastomers (ExxonMobil Chemical Company, Houston Tex.). It is understood that the use of the terms “halogenated” or “brominated” are not limited to the method of halogenation of the copolymer, but merely descriptive of the copolymer which comprises the isobutylene derived units, the p-methylstyrene derived units, and the p-halomethylstyrene derived units.

These functionalized polymers preferably have a substantially homogeneous compositional distribution such that at least 95% by weight of the polymer has a p-alkylstyrene content within 10% of the average p-alkylstyrene content of the polymer. More preferred polymers are also characterized by a narrow molecular weight distribution (Mw/Mn) of less than 5, more preferably less than 2.5, a preferred viscosity average molecular weight in the range of from 200,000 up to 2,000,000 and a preferred number average molecular weight in the range of from 25,000 to 750,000 as determined by gel permeation chromatography.

The copolymers may be prepared by a slurry polymerization of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional derived unit.

Preferred halogenated poly(isobutylene-co-alkylstyrene), preferably halogenated poly(isobutylene-co-p-methylstyrene), are brominated polymers which generally contain from 0.1 to 5 wt % of bromomethyl groups. In yet another embodiment, the amount of bromomethyl groups is from 0.2 to 2.5 wt %. Expressed another way, preferred copolymers contain from 0.05 up to 2.5 mole % of bromine, based on the weight of the polymer, more preferably from 0.1 to 1.25 mole % bromine, and are substantially free of ring halogen or halogen in the polymer backbone chain. In one embodiment of the invention, the interpolymer is a copolymer of C₄ to C₇ isomonoolefin derived units and alkylstyrene, preferably a p-methylstyrene, derived units and preferably a p-halomethylstyrene derived units, wherein the p-halomethylstyrene units are present in the interpolymer from 0.4 to 1 mol % based on the interpolymer. In another embodiment, the p-halomethylstyrene is p-bromomethylstyrene. The Mooney Viscosity (1+8, 125° C., ASTM D1646, modified) is from 30 to 60 MU.

The elastomeric component present in compositions of the invention may contain various amounts of one, two, or more different elastomers. For example, embodiments of compositions of the invention may contain from 5 to 100 phr of halogenated butyl rubber, from 5 to 95 phr of star-branched butyl rubber, from 5 to 95 phr of halogenated star-branched butyl rubber, or from 5 to 95 phr of halogenated poly(isobutylene-co-alkylstyrene), preferably halogenated poly(isobutylene-co-p-methylstyrene). In another embodiment, the compositions contain from 40 to 100 phr of halogenated poly(isobutylene-co-alkylstyrene), preferably halogenated poly(isobutylene-co-p-methylstyrene), and/or from 40 to 100 phr of halogenated star-branched butyl rubber (HSBB). The elastomeric compositions of the invention may contain other elastomers, or so called “secondary” elastomer components.

Secondary Elastomeric Component

A secondary elastomeric component may be present in compositions of the present invention. These rubbers include, but are not limited to, natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; poly(isobutylene-co-alkylstyrene), preferably isobutylene/methylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.

A secondary rubber component may also be present in the composition and air barrier of the invention. An embodiment of the secondary rubber component present is natural rubber. Natural rubbers are described in detail by Subramaniam in RUBBER TECHNOLOGY 179-208 (1995). Desirable embodiments of the natural rubbers of the present invention are selected from the group consisting of Malaysian rubber such as SMR CV, SMR 5, SMR 10, SMR 20, and SMR 50 and mixtures thereof, wherein the natural rubbers have a Mooney viscosity at 100° C. (ML 1+4) of from 30 to 120, more preferably from 40 to 65. The Mooney viscosity test referred to herein is in accordance with ASTM D-1646.

Some commercial examples of synthetic secondary rubbers useful in the present invention are NATSYN™ (Goodyear Chemical Company), and BUDENE™ 1207 or BR 1207 (Goodyear Chemical Company). A desirable rubber is high cis-polybutadiene (cis-BR). By “cis-polybutadiene” or “high cis-polybutadiene”, it is meant that 1,4-cis polybutadiene is used, wherein the amount of cis component is at least 95%. An example of high cis-polybutadiene commercial products used in the composition BUDENE™ 1207. A suitable ethylene-propylene rubber is commercially available as VISTALON™ (ExxonMobil Chemical Company).

In one embodiment of the invention, a so called semi-crystalline copolymer (SCC) is present as the secondary rubber. Semi-crystalline copolymers are described in U.S. Ser. No. 09/569,363, filed on May 11, 2000 (assigned to the assignee of the present invention). Generally, the SCC is a copolymer of ethylene or propylene derived units and α-olefin derived units, the α-olefin having from 4 to 16 carbon atoms in one embodiment, and in another embodiment the SCC is a copolymer of ethylene derived units and α-olefin derived units, the α-olefin having from 4 to 10 carbon atoms, wherein the SCC has some degree of crystallinity. In a further embodiment, the SCC is a copolymer of 1-butene derived units and another α-olefin derived unit, the other α-olefin having from 5 to 16 carbon atoms, wherein the SCC also has some degree of crystallinity. The SCC can also be a copolymer of ethylene and styrene.

The secondary rubber component of the elastomer composition may be present in a range from up to 50 phr in one embodiment, from up to 40 phr in another embodiment, and from up to 30 phr in yet another embodiment.

Thermoplastic Resin

The compositions of the invention may also include a thermoplastic resin, a filler, and/or an exfoliating clay. Suitable thermoplastic resins include polyolefins, nylons, and other polymers. The filler, if present, is typically selected from calcium carbonate, clay, mica, silica and silicates, talc, titanium dioxide, starch and other organic fillers such as wood flower, and carbon black, and mixtures thereof. The exfoliated clay, if present, is typically selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof. These compositions are useful in air barrier applications such as, for example, innerliners for a tires.

Thermoplastic resins suitable for practice of the present invention may be used singly or in combination and are resins containing nitrogen, oxygen, halogen, sulfur or other groups capable of interacting with an aromatic functional groups such as halogen or acidic groups. The resins are present in the nanocomposite from 30 to 90 wt % of the nanocomposite in one embodiment, and from 40 to 80 wt % in another embodiment, and from 50 to 70 wt % in yet another embodiment. In yet another embodiment, the resin is present at a level of greater than 40 wt % of the nanocomposite, and greater than 60 wt % in another embodiment.

Suitable thermoplastic resins include resins selected from the group consisting or polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK) and mixtures thereof.

Suitable thermoplastic polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethyleneisophthalamide (nylon-6, IP) and the condensation product of 11-amino-undecanoic acid (nylon-11). Additional examples of satisfactory polyamides (especially those having a softening point below 275° C.) are described in 16 ENCYCLOPEDIA OF CHEMICAL TECHNOLOGY 1-105 (John Wiley & Sons 1968), CONCISE ENCYCLOPEDIA OF POLYMER SCIENCE AND 748-761 (John Wiley & Sons, 1990), and 10 ENCYCLOPEDIA OF POLYMER SCIENCE AND TECHNOLOGY 392-414 (John Wiley & Sons 1969). Commercially available thermoplastic polyamides may be advantageously used in the practice of this invention, with linear crystalline polyamides having a softening point or melting point between 160 and 260° C. being preferred.

Suitable thermoplastic polyesters which may be employed include the polymer reaction products of one or a mixture of aliphatic or aromatic polycarboxylic acids esters of anhydrides and one or a mixture of diols. Examples of satisfactory polyesters include poly (trans-1,4-cyclohexylene C₂₋₆ alkane dicarboxylates such as poly(trans-1,4-cyclohexylene succinate) and poly (trans-1,4-cyclohexylene adipate); poly (cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly (C₂₋₄ alkylene terephthalates) such as polyethyleneterephthalate and polytetramethylene-terephthalate, poly (C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Poly(phenylene ether) (PPE) thermoplastic resins which may be used in accordance with this invention are well known, commercially available materials produced by the oxidative coupling polymerization of alkyl substituted phenols. They are generally linear, amorphous polymers having a glass transition temperature in the range of 190° C. to 235° C. These polymers, their method of preparation and compositions with polystyrene are further described in U.S. Pat. No. 3,383,435.

Other thermoplastic resins which may be used include the polycarbonate analogs of the polyesters described above such as segmented poly (ether co-phthalates); polycaprolactone polymers; styrene resins such as copolymers of styrene with less than 50 mol % of acrylonitrile (SAN) and resinous copolymers of styrene, acrylonitrile and butadiene (ABS); sulfone polymers such as polyphenyl sulfone; copolymers and homopolymers of ethylene and C₂ to C₈ α-olefins, in one embodiment a homopolymer of propylene derived units, and in another embodiment a random copolymer or block copolymer of ethylene derived units and propylene derived units, and like thermoplastic resins as are known in the art.

In another embodiment the compositions of this invention further comprising any of the thermoplastic resins (also referred to as a thermoplastic or a thermoplastic polymer) described above are formed into dynamically vulcanized alloys.

The term “dynamic vulcanization” is used herein to connote a vulcanization process in which the engineering resin and a vulcanizable elastomer are vulcanized under conditions of high shear. As a result, the vulcanizable elastomer is simultaneously crosslinked and dispersed as fine particles of a “micro gel” within the engineering resin matrix.

Dynamic vulcanization is effected by mixing the ingredients at a temperature which is at or above the curing temperature of the elastomer in equipment such as roll mills, Banbury.RTM. mixers, continuous mixers, kneaders or mixing extruders, e.g., twin screw extruders. T he unique characteristic of the dynamically cured compositions is that, notwithstanding the fact that the elastomer component may be fully cured, the compositions can be processed and reprocessed by conventional rubber processing techniques such as extrusion, injection molding, compression molding, etc. Scrap or flashing can be salvaged and reprocessed.

Particularly preferred thermoplastic polymers useful in DVA's of this invention include engineering resins selected from the group consisting of polyamides, polycarbonates, polyesters, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK) and mixtures thereof. Preferred engineering resins are polyamides. The more preferred polyamides are nylon 6 and nylon 11. Preferably the engineering resin(s) may suitably be present in an amount ranging from about 10 to 98 weight percent, preferably from about 20 to 95 weight percent, the elastomer may be present in an amount ranging from about 2 to 90 weight percent, preferably from about 5 to 80 weight percent, based on the polymer blend. Preferably the elastomer is present in said composition as particles dispersed in said engineering resin.

Polybutene Oil

Polybutene oils useful in the practice of this invention include polybutene processing oils having an Mn of less than 15,000. Preferred polybutene oils also include homopolymer or copolymer of olefin derived units having from 3 to 8 carbon atoms in one embodiment, preferably from 4 to 6 carbon atoms in another embodiment. In yet another embodiment, the polybutene is a homopolymer or copolymer of a C₄ raffinate. An embodiment of preferred low molecular weight polymers termed “polybutene” polymers is described in, for example, SYNTHETIC LUBRICANTS AND HIGH-PERFORMANCE FUNCTIONAL FLUIDS 357-392 (Leslie R. Rudnick & Ronald L. Shubkin, ed., Marcel Dekker 1999) (hereinafter “polybutene processing oil” or “polybutene”).

In one embodiment of the invention, the polybutene processing oil is a copolymer comprising at least isobutylene derived units, and optionally 1-butene derived units, and/or 2-butene derived units. In one embodiment, the polybutene is a homopolymer if isobutylene, or a copolymer of isobutylene and 1-butene or 2-butene, or a terpolymer of isobutylene and 1-butene and 2-butene, wherein the isobutylene derived units are from 40 to 100 wt % of the copolymer, the 1-butene derived units are from 0 to 40 wt % of the copolymer, and the 2-butene derived units are from 0 to 40 wt % of the copolymer. In another embodiment, the polybutene is a copolymer or terpolymer wherein the isobutylene derived units are from 40 to 99 wt % of the copolymer, the 1-butene derived units are from 2 to 40 wt % of the copolymer, and the 2-butene derived units are from 0 to 30 wt % of the copolymer. In yet another embodiment, the polybutene is a terpolymer of the three units, wherein the isobutylene derived units are from 40 to 96 wt % of the copolymer, the 1-butene derived units are from 2 to 40 wt % of the copolymer, and the 2-butene derived units are from 2 to 20 wt % of the copolymer. In yet another embodiment, the polybutene is a homopolymer or copolymer of isobutylene and 1-butene, wherein the isobutylene derived units are from 65 to 100 wt % of the homopolymer or copolymer, and the 1-butene derived units are from 0 to 35 wt % of the copolymer.

Polybutene processing oils useful in the invention typically have a number average molecular weight (Mn) of less than 10,000 in one embodiment, less than 8000 in another embodiment, and less than 6000 in yet another embodiment. In one embodiment, the polybutene oil has a number average molecular weight of greater than 400, and greater than 700 in another embodiment, and greater than 900 in yet another embodiment. A preferred embodiment can be a combination of any lower limit with any upper limit herein. For example, in one embodiment of the polybutene of the invention, the polybutene has a number average molecular weight of from 400 to 10,000, and from 700 to 8000 in another embodiment. Useful viscosities of the polybutene processing oil ranges from 10 to 6000 cSt (centiStokes) at 100° C. in one embodiment, and from 35 to 5000 cSt at 100° C. in another embodiment, and is greater than 35 cSt at 100° C. in yet another embodiment, and greater than 100 cSt at 100° C. in yet another embodiment.

Commercial examples of such a processing oil are the PARAPOL™ Series of processing oils (ExxonMobil Chemical Company, Houston Tex.), such as PARAPOL™ 450, 700, 950, 1300, 2400 and 2500. The commercially available PARAPOL™ Series of polybutene processing oils are synthetic liquid polybutenes, each individual formulation having a certain molecular weight, all formulations of which can be used in the composition of the invention. The molecular weights of the PARAPOL™ oils are from 420 Mn (PARAPOL™ 450) to 2700 Mn (PARAPOL™ 2500) as determined by gel permeation chromatography. The MWD of the PARAPOL™ oils range from 1.8 to 3 in one embodiment, and from 2 to 2.8 in another embodiment.

Below, Table 1 shows some of the properties of the PARAPOL™ oils useful in embodiments of the present invention, wherein the viscosity was determined as per ASTM D445-97, and the molecular weight by gel permeation chromatography.

TABLE 1
Properties of Individual PARAPOL ™ Grades of Polybutene

| | | Viscosity @ |
|---|---|---|
| Grade | Mn | 100° C., cSt |
| 450 | 420 | 10.6 |
| 700 | 700 | 78 |
| 950 | 950 | 230 |
| 1300 | 1300 | 630 |
| 2400 | 2350 | 3200 |
| 2500 | 2700 | 4400 |

Other properties of PARAPOL™ processing oils are as follows: the density (g/mL) of PARAPOL™ processing oils varies from about 0.85 (PARAPOL™ 450) to 0.91 (PARAPOL™ 2500). The bromine number (CG/G) for PARAPOL™ ranges from 40 for the 450 Mn processing oil, to 8 for the 2700 Mn processing oil.

The elastomeric composition of the invention may include one or more types of polybutene as a mixture, blended either prior to addition to the elastomer, or with the elastomer. The amount and identity (e.g., viscosity, Mn, etc.) or the polybutene processing oil mixture can be varied in this manner. Thus, PARAPOL™ 450 can be used when low viscosity is desired in the composition of the invention, while PARAPOL™ 2500 can be used when a higher viscosity is desired, or compositions thereof to achieve some other viscosity or molecular weight. In this manner, the physical properties of the composition can be controlled. More particularly, the phrases “polybutene processing oil”, or “polybutene processing oils” include a single oil or a composition of two or more oils used to obtain any viscosity or molecular weight (or other property) desired, as specified in the ranges disclosed herein.

The polybutene processing oil or oils are present in the elastomeric composition of the invention from 1 to 60 phr in one embodiment, and from 2 to 40 phr in another embodiment, from 4 to 35 phr in another embodiment, and from 5 to 30 phr in yet another embodiment. Preferably, the polybutene processing oil does not contain aromatic groups or unsaturation.

In additional embodiments naphthenic processing oil(s) may also be present. Preferably the naphthenic processing oil(s) is present at 1 to 30 phr, more preferably 5 to 25 phr, more preferably 5 to 20 phr.

Carbon Black

Carbon black is produced by the incomplete combustion of organic substances. There are two main production processes for the manufacture of carbon black: the oil furnace process and the thermal process. In the furnace process a fuel is burned in an excess of air to produce finely divided carbon. There are several distinct production segments: reaction; filtration and separation; pelletizing; and drying. The thermal process is similar, but is a continuous furnace process. The American Society of Testing Materials (ASTM) has established a carbon black classification system based on particle size and surface oxidation, ASTM D1765. The degree of surface oxidation affects the cure time of carbon-black filled rubber compounds. The “N” denotes normal curing blacks and the “S” refers to slow curing blacks. After N or S, the first number of the three-digit suffix identifies the particle size and the remaining two digits are assigned arbitrarily.

Carbon black owes its reinforcing character in rubber to the size, shape and surface chemistry of the aggregate structures which consists of primary particles essentially spherical in shape that are chemically bonded to one another. The two most important properties of carbon black are surface area and structure. Surface area depends inversely upon the size of the primary particles, and is one measure of the area available for physical interaction with the polymer. Surface area ranges from 10-140 m²/g with thermal blacks having the lowest values based on nitrogen adsorption (N₂SA) via ASTM D4820. Surface area is also measured by cetyl trimethylammonium bromide (CTAB) absorption. The structure of carbon black depends upon the size and grouping of these primary particles in the aggregate. The more primary particles in the aggregate, the higher structure of the carbon black due to the more complex shape and void volume (porosity). Structure varies from 35-130 cm³/100 gm as measured by dibutylphthalate (DBP) oil absorption via ASTM D2414. Useful grades of carbon black as described in RUBBER TECHNOLOGY 59-85 (1995) range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762. Embodiments of the carbon black useful in, for example, innerliners or innertubes are N550, N650, N660, N762, N990, and the like.

The compositions of this invention include carbon black having a surface area of less than 30 m²/g and a dibutylphthalate oil absorption of less than 80 cm³/100 gm. Carbon blacks useful in the invention include, but are not limited to N762, N774, N907, N990, Regal 85, and Regal 90. Below, Table 2, show properties of useful carbon blacks.

TABLE 2
Properties of Individual Carbon Black Grades

| | N₂SA, | DBP Absorption, |
|---|---|---|
| Grade | m²/gm | cm³/100 gm |
| N660 | 34 | 90 |
| N754 | 25 | 58 |
| N762 | 26 | 64 |
| N774 | 28 | 70 |
| N787 | 30 | 80 |
| N907 | 10 | 38 |
| N990 | 7 | 42 |
| N991 | 10 | 38 |
| Regal 85 | 23 | 33 |
| Regal 90 | 23 | 32 |
| ARO 60 | 23 | 58 |
| SL 90 | 25 | 58 |

The carbon black having a surface area of less than 30 m²/g and a dibutylphthalate oil absorption of less than 80 cm³/100 gm is typically present at a level of from 10 to 200 phr, preferably 20 to 180 phr, more preferably 30 to 160 phr, and more preferably 40 to 140 phr.

Filler and Clay

The elastomeric composition may further include one or more filler components such as calcium carbonate, clay, mica, silica and silicates, talc, titanium dioxide, starch and other organic fillers such as wood flower, carbon black having a surface area greater than 30 m²/g, and or carbon black having a dibutylphthalate oil absorption of greater than 80 cm³/100 gm. The filler components are typically present at a level of from 10 to 200 phr of the composition, more preferably from 40 to 140 phr. In some embodiments, two or more carbon blacks are used in combination for example Regal 85 is a carbon black that has multiple particle sizes, rather than just one. Combinations also include those where the carbon blacks have different surface areas. Likewise, two different blacks which have been treated differently may also be used. For example a carbon black that has been chemically treated may be combined with a carbon black that has not. The carbon black no having a surface area of less than 30 m²/g and/or not a dibutylphthalate oil absorption of less than 80 cm³/100 gm may typically be present at a level of from 0 to 200 phr, preferably 10 to 200 phr, preferably 20 to 180 phr, more preferably 30 to 160 phr, and more preferably 40 to 140 phr.

Exfoliated clays may also be present in the composition. These clays, also referred to as “nanoclays”, are well known, and their identity, methods of preparation and blending with polymers is disclosed in, for example, JP 2000109635, 2000109605, 11310643; DE 19726278; WO98/53000; U.S. Pat. Nos. 5,091,462, 4,431,755, 4,472,538, and 5,910,523. Swellable layered clay materials suitable for the purposes of this invention include natural or synthetic phyllosilicates, particularly smectic clays such as montmorillonite, nontronite, beidellite, volkonskoite, laponite, hectorite, saponite, sauconite, magadite, kenyaite, stevensite and the like, as well as vermiculite, halloysite, aluminate oxides, hydrotalcite and the like. These layered clays generally comprise particles containing a plurality of silicate platelets having a thickness of from 4-20 Å in one embodiment, 8-12 Å in another embodiment, bound together and contain exchangeable cations such as Na⁺, Ca⁺², K⁺ or Mg⁺² present at the interlayer surfaces.

The layered clay may be intercalated and exfoliated by treatment with organic molecules (swelling agents) capable of undergoing ion exchange reactions with the cations present at the interlayer surfaces of the layered silicate. Suitable swelling agents include cationic surfactants such as ammonium, alkylamines or alkylammonium (primary, secondary, tertiary and quaternary), phosphonium or sulfonium derivatives of aliphatic, aromatic or arylaliphatic amines, phosphines and sulfides. Desirable amine compounds (or the corresponding ammonium ion) are those with the structure R₁R₂R₃N, wherein R₁, R₂, and R₃ are C₁ to C₂₀ alkyls or alkenes which may be the same or different. In one embodiment, the exfoliating agent is a so called long chain tertiary amine, wherein at least R₁ is a C₁₄ to C₂₀ alkyl or alkene.

Another class of swelling agents include those which can be covalently bonded to the interlayer surfaces. These include polysilanes of the structure —Si(R′)₂R² where R′ is the same or different at each occurrence and is selected from alkyl, alkoxy or oxysilane and R² is an organic radical compatible with the matrix polymer of the composite.

Other suitable swelling agents include protonated amino acids and salts thereof containing 2-30 carbon atoms such as 12-aminododecanoic acid, epsilon-caprolactam and like materials. Suitable swelling agents and processes for intercalating layered silicates are disclosed in U.S. Pat. Nos. 4,472,538, 4,810,734, 4,889,885 as well as WO92/02582.

In a preferred embodiment of the invention, the exfoliating additive is combined with a halogenated polymer. In one embodiment, the additive includes all primary, secondary and tertiary amines and phosphines; alkyl and aryl sulfides and thiols; and their polyfunctional versions. Desirable additives include: long-chain tertiary amines such as N,N-dimethyl-octadecylamine, N,N-dioctadecyl-methylamine, so called dihydrogenated tallowalkyl-methylamine and the like, and amine-terminated polytetrahydrofuran; long-chain thiol and thiosulfate compounds like hexamethylene sodium thiosulfate. In another embodiment of the invention, improved interpolymer impermeability is achieved by the presence of polyfunctional curatives such as hexamethylene bis(sodium thiosulfate) and hexamethylene bis(cinnamaldehyde).

The amount of clay or exfoliated clay incorporated in the nanocomposites in accordance with this invention is sufficient to develop an improvement in the mechanical properties or barrier properties of the nanocomposite, e.g., tensile strength or air/oxygen permeability. Amounts generally will range from 0.5 to 15 wt % in one embodiment, and from 1 to 10 wt % in another embodiment, and from 1 to 5 in yet another embodiment, based on the polymer content of the nanocomposite. Expressed in parts per hundred rubber, the clay or exfoliated clay may be present from 1 to 30 phr in one embodiment, and from 3 to 20 phr in another embodiment. In one embodiment, the exfoliated clay is an alkylamine-exfoliated clay.

Curing Agents and Accelerators

The compositions produced in accordance with the present invention typically contain other components and additives customarily used in rubber mixes, such as pigments, accelerators, cross-linking and curing materials, antioxidants, antiozonants, and fillers. In one embodiment, processing aids (resins) such as naphthenic, aromatic or paraffinic extender oils may be present from 1 to 30 phr. In another embodiment, naphthenic, aliphatic, paraffinic and other aromatic resins and oils are substantially absent from the composition. By “substantially absent”, it is meant that naphthenic, aliphatic, paraffinic and other aromatic resins are present, if at all, to an extent no greater than 2 phr in the composition.

Generally, polymer compositions, e.g., those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR, RUBBER WORLD 18-23 (1991). Cross-linking and curing agents include sulfur, zinc oxide, and fatty acids. Peroxide cure systems may also be used. Generally, polymer compositions may be crosslinked by adding curative molecules, for example sulfur, metal oxides (i.e., zinc oxide), organometallic compounds, radical initiators, etc. followed by heating. In particular, the following are common curatives that will function in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and Al(Stearate)₃), or with stearic acid, and either a sulfur compound or an alkylperoxide compound. (See also, Formulation Design and Curing Characteristics of NBR Mixes for Seals, RUBBER WORLD 25-30 (1993). This method may be accelerated and is often used for the vulcanization of elastomer compositions.

Accelerators include amines, guanidines, thioureas, thiazoles, thiurams, sulfenamides, sulfenimides, thiocarbamates, xanthates, and the like. Acceleration of the cure process may be accomplished by adding to the composition an amount of the accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N, N′-diethyl thiourea.

In one embodiment of the invention, at least one curing agent is present from 0.2 to 15 phr, and from 0.5 to 10 phr in another embodiment. Curing agents include those components described above that facilitate or influence the cure of elastomers, such as metals, accelerators, sulfur, peroxides, and other agents common in the art, and as described above.

Processing

Mixing of the components may be carried out by combining the polymer components and the clay in the form of an intercalate in any suitable mixing device such as a Banbury™ mixer, Brabender™ mixer or preferably a mixer/extruder. Mixing is performed at temperatures in the range from up to the melting point of the elastomer and/or secondary rubber used in the composition in one embodiment, from 80° C. up to 340° C. in another embodiment, and from 120° C. to 300° C. in yet another embodiment, under conditions of shear sufficient to allow the clay intercalate to exfoliate and become uniformly dispersed within the polymer to form the nanocomposite.

In the example compositions, the mixing was performed in a BR Banbury™ internal mixer by techniques known in the art. Typically, from 70% to 100% of the elastomer or elastomers is first mixed for 20 to 90 seconds, or until the temperature reaches from 40 to 60° C. Then, ¾ of the filler, and the remaining amount of elastomer, if any, is typically added to the mixer, and mixing continues until the temperature reaches from 90 to 150° C. Next, the remaining filler is added, as well as the processing oil, and mixing continues until the temperature reaches from 140 to 190° C. The finished mixture is then finished by sheeting on an open mill and allowed to cool to from 60° C. to 100° C. when the curatives are added.

Mixing with the clays is performed by techniques known to those skilled in the art, wherein the clay is added to the polymer at the same time as the carbon black in one embodiment. The polybutene processing oil is typically added later in the mixing cycle after the carbon black and clay have achieved adequate dispersion in the elastomeric matrix.

The cured compositions of the invention can include various elastomers and fillers with the polybutene processing oil. The compositions of the invention typically include isobutylene-based elastomers such as halogenated poly(isobutylene-co-p-methylstyrene), butyl rubber, halogenated butyl rubber, or halogenated star-branched butyl rubber (HSBB) either alone, or some combination with one another, with the polybutene processing oil being present from 5 to 30 phr in one embodiment.

In one embodiment, the composition is halogenated poly(isobutylene-co-p-methylstyrene) from 50 to 100 phr that may include natural rubber from 5 to 50 phr, and polybutene processing oil present from 2 to 30 phr, a filler such as a carbon black from 20 to 180 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 5 phr.

In another embodiment, the composition may be a HSBB present from 50 to 100 phr that may include a halogenated poly(isobutylene-co-p-methylstyrene) from 5 to 95 phr in one embodiment, and from 20 to 70 phr in another embodiment, and polybutene processing oil present from 3 to 30 phr, a filler such as a carbon black from 20 to 180 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 5 phr.

In yet another embodiment, the composition may be a halogenated butyl rubber present from 50 to 100 phr that may include a halogenated poly(isobutylene-co-p-methylstyrene) from 5 to 95 phr in one embodiment, and from 20 to 70 phr in another embodiment, and polybutene processing oil present from 3 to 30 phr, a filler such as a carbon black from 20 to 180 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 5 phr.

The isobutylene-based elastomer useful in the invention can be blended with various other rubbers or plastics as disclosed herein, in particular thermoplastic resins such as nylons or polyolefins such as polypropylene or copolymers of polypropylene. These compositions are useful in air barriers such as bladders and innerliners, air sleeves (such as in air shocks), diaphragms, as well as other applications where high air or oxygen retention is desirable. In one embodiment, the cured composition has an air (air, oxygen or nitrogen at 65° C.) permeability of from 1.2×10⁻⁸ to 4×10⁻⁸ cm³-cm/cm²-sec-atm, and from 1.5×10⁻⁸ to 3.5×10⁻⁸ cm³-cm/cm²-sec-atm in another embodiment.

In one embodiment, an air barrier can be made by the method of combining at least one random copolymer comprising a C₄ to C₇ isomonoolefin derived unit, at least one filler, and polybutene oil having a number average molecular weight greater than 400, and at least one cure agent; and curing the combined components as described above.

In another embodiment the compositions of this invention include:
1. A composition comprising:
   1) an elastomer comprising at least 30 mol % of isobutylene;
   2) carbon black having a surface area of less than 30 m²/g and a dibutylphthalate oil absorption of less than 80 cm³/100 gm; and
   3) polybutene oil having a number average molecular weight greater than 400.
2. The composition of paragraph 1 where the elastomer comprises at least 40 mol % of isobutylene.
3. The composition of any of the above paragraphs where the carbon black has a surface area of less than 25 m²/g and a dibutylphthalate oil absorption of less than 75 cm³/100 gm.
4. The composition of any of the above paragraphs where polybutene oil has a number average molecular weight between 700 and 15,000.
5. The composition of any of the above paragraphs where the elastomer is present at 20 to 100 phr, the carbon black is present at 10 to 200 phr and the polybutene oil is present at 2 to 40 phr.
6. The composition of any of the above paragraphs where the elastomer is present at 20 to 100 phr, the carbon black is present at 20 to 180 phr and the polybutene oil is present at 2 to 30 phr.
7. The composition of any of the above paragraphs, wherein the elastomer is selected from a halogenated poly(isobutylene-co-alkylstyrene), halogenated star-branched butyl rubber, halogenated butyl rubber, butyl rubber, and mixtures thereof.
8. The composition of any of the above paragraphs, also comprising a thermoplastic polymer.
9. The composition of any of the above paragraphs, wherein the polybutene has a number average molecular weight between 400 and 10,000.
10. The composition of any of the above paragraphs, further comprising one or more filler components selected from calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm.
11. The composition of any of the above paragraphs, wherein the composition also includes an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof.
12. The composition of any of the above paragraphs further comprising one or more carbon blacks having a surface area of greater than 30 m²/g and/or a dibutylphthalate oil absorption of greater than 80 cm³/100 gm.
13. The composition of any of the above paragraphs where the elastomer comprises star branched butyl rubber.
14. The composition of any of the above paragraphs where the elastomer comprises halogenated butyl rubber.
15. The composition of any of the above paragraphs where naphthenic processing oil, aliphatic, paraffinic and other aromatic resins or oils are substantially absent.
16. The composition of any of paragraphs 1 to 15 further comprising naphthenic processing oil.
17. The composition of any of the above paragraphs where the polybutene oil comprises a copolymer of butene derived units and one or more olefin derived units having from 3 to 8 carbon atoms.
18. The composition of any of the above paragraphs 1 to 17 where the polybutene oil comprises a homopolymer or copolymer of a C₄ raffinate.
19. The composition of any of the above paragraphs 1 to 17 where the polybutene oil comprises a homopolymer of isobutylene, or a copolymer of isobutylene and 1-butene or 2-butene, or a terpolymer of isobutylene and 1-butene and 2-butene, wherein the isobutylene derived units are from 40 to 100 wt % of the copolymer, the 1-butene derived units are from 0 to 40 wt % of the copolymer, and the 2-butene derived units are from 0 to 40 wt % of the copolymer.
20. The composition of any of the above paragraphs where the polybutene oil has a viscosity of from 10 to 6000 cSt at 100° C.
21. The composition of any of the above paragraphs where the polybutene oil has a viscosity of from 35 to 5000 cSt at 100° C.
22. The composition of any of the above paragraphs further comprising an engineering resin selected from the group consisting of polyamides, polycarbonates, polyesters, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK) and mixtures thereof.
23. The composition of any of the above paragraphs where the elastomer comprising at least 30 mole % of isobutylene comprises poly(isobutylene-co-alkylstyrene).
24. The composition of any of the above paragraphs where the elastomer comprising at least 30 mole % of isobutylene comprises halogenated poly(isobutylene-co-alkylstyrene).
25. The composition of any of the above paragraphs where the elastomer comprising at least 30 mole % of isobutylene comprises a halogenated poly(isobutylene-co-alkylstyrene) having a p-bromomethylstyrene content of from 0.1 to 5 wt % based on the weight of the copolymer.
26. The composition of any of the above paragraphs, wherein the polybutene has a viscosity of from 10 to 6000 cSt at 100° C.
27. The composition of any of the above paragraphs, wherein the polybutene has a viscosity of from 35 to 5000 cSt at 100° C.
28. The air barrier of any of the above paragraphs, also comprising a secondary elastomer selected from natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; isobutylene/alkylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.
29. A dynamically vulcanized alloy comprising the composition of any of the above paragraphs and an engineering resin.
30. A dynamically vulcanized alloy comprising the composition of any of the above paragraphs and polyamide.
31. An innerliner for a tire comprising the composition of any of the above paragraphs.
32. An innertube for a tire comprising the composition of paragraphs 1 to 30.
33. An air barrier comprising the composition of any of paragraphs 1 to 30.
34. An air barrier comprising the composition of any of paragraphs 1 to 30, wherein the air permeability of the barrier is from 1.2×10⁻⁸ to 4×10⁻⁸ cm³-cm/cm²-sec-atm at 65° C.
35. A method to prepare a barrier comprising:
   a) combining:
      1) an elastomer comprising at least 30 mol % of isobutylene;
      2) carbon black having a surface area of less than 30 m²/g and a dibutylphthalate oil absorption of less than 80 cm³/100 gm;
      3) polybutene oil having a number average molecular weight greater than 400;
      4) optionally, a second elastomer selected from natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; isobutylene/alkylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.
      5) a filler selected from the group consisting of calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm;
      6) optionally, an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof;
      7) optionally, a thermoplastic resin; and
      8) a curing agent, and
   b) curing the composition.
36. The method of paragraph 35 wherein the thermoplastic polymer comprises an engineering resin.
37. A method to prepare an air barrier comprising combining the composition of any of paragraphs 1 to 30 with a curing agent and curing the combination.
38. A method to prepare a tire innerliner comprising combining the composition of any of paragraphs 1 to 30 with a curing agent, curing the combination, forming the cured combination into a film and incorporating the film into a tire.
39. A method to prepare a tire innerliner comprising combining the composition of any of paragraphs 1 to 30 with a curing agent, curing the combination, forming the cured combination into a tube and incorporating the tube into a tire.
   Test Methods

Cure properties were measured using an ODR 2000 at the indicated temperature and 3 degree arc or an MDR 2000 at the indicated temperature and 0.5 degree arc. Test specimens were cured at the indicated temperature, typically from 150° C. to 160° C., for a time corresponding to T_{c}90+ appropriate mold lag. When possible, standard ASTM tests were used to determine the cured compound physical properties (see Table 3). Stress/strain properties (tensile strength, elongation at break, modulus values, energy to break) were measured at room temperature using an Instron 4202. Shore A hardness was measured at room temperature by using a Zwick Duromatic. The error (2σ) in measuring 100% Modulus is ±0.11 MPa units; the error (2σ) in measuring elongation is ±13% units.

The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “Tc” are cure times in minutes, and “Ts” is scorch time” in minutes.

Molecular weight of the PARAPOL™ polybutene processing oil was determined by gel permeation chromatography, and the values of number average molecular weight (Mn) obtained have an error of ±20%. The techniques for determining the molecular weight (Mn and Mw) and molecular weight distribution (MWD) are generally described in U.S. Pat. No. 4,540,753 to Cozewith et al. and references cited therein, and in Verstrate et al., 21 MACROMOLECULES 3360 (1988). In a typical measurement, a 3-column set is operated at 30° C. The elution solvent used may be stabilized tetrahydrofuran (THF), or 1,2,4-trichlorobenzene (TCB). The columns are calibrated using polystyrene standards of precisely known molecular weights. A correlation of polystyrene retention volume obtained from the standards, to the retention volume of the polymer tested yields the polymer molecular weight. The viscosity of the PARAPOL™ polybutene processing oil (Table 1) was determined as per ASTM D445-97.

Tensile measurements were done at ambient temperature on Instron Series IX Automated Materials Testing System 6.03.08. Micro tensile specimens (dog-bone shaped) width of 0.08 inches (0.20 cm) and a length of 0.2 inches (0.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in tensile measurements is ±0.47 MPa units.

Adhesion was tested using a one-inch strip adhesion, wherein one inch x three inch adhesive bonds to Kraft paper are prepared. Samples are hung horizontally (in peel mode) in an air circulating oven and a 100 gram weight is suspended from the free end of the bond. The oven temperature is raised 10° F. (4.1° C.) every 15 minutes. The peel-fail temperature is the average of three readings.

The error in the fatigue-to-failure values is ±20%.

Oxygen permeability was measured using a MOCON OxTran Model 2/61 operating under the principle of dynamic measurement of oxygen transport through a thin film as published by R. A. Pasternak et al. in 8 JOURNAL OF POLYMER SCIENCE: PART A-2 467 (1970). The units of measure are cc-mil/m²-day-mmHg. Generally, the method is as follows: flat film or rubber samples are clamped into diffusion cells which are purged of residual oxygen using an oxygen free carrier gas. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Air permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units. Other test methods are described in Table 3. Table 4 provides properties and commercial sources of some of the ingredients used herein.

TABLE 3
Test Methods

| Parameter | Units | Test |
|---|---|---|
| Mooney Viscosity | ML 1 + 8, 125° C., MU | ASTM D 1646 |
| (BIMS polymer) | | (modified) |
| Mooney Viscosity | ML 1 + 4, 100° C., MU | ASTM D 1646 |
| (composition) | | |
| Air permeability | cm³-cm/cm²-sec-atm | See text |
| Mooney Viscosity | ML 1 + 4, 100° C., MU | ASTM D 1646 |
| (compound) | | |
| Mooney | T_{S}10, 125° C., minutes | ASTM D 1646 |
| Scorch Time | | |
| Oscillating Disk | | |
| Rheometer (ODR) | | |
| @ 160° C., ± 3° arc | | |
| Or | | |
| Moving Die | | |
| Rheometer (MDR) @ | | |
| 160° C., ± 0.5° arc | | |
| ML | deciNewton · meter | ASTM D 2084 |
| MH | dNewton · m | |
| Tₛ2 | minute | |
| T_{c}90 | minute | |
| Cure rate | dN · m/minute | |
| Physical Properties | | |
| press cured Tc 90 + 2 | | |
| min @ 160° C. | | |
| Hardness | Shore A | ASTM D 2240 |
| Modulus 100% | MPa | ASTM D 412 die C |
| Tensile Strength | MPa | |
| Elongation at Break | % | |
| Energy to Break | N/mm | |
| Tear Strength | N/mm | ASTM D 624 |
| Die B & Die C | | |

### EXAMPLES

The present invention, while not meant to be limiting by, may be better understood by reference to the following examples (Compositions 1-26, with Composition 1-9 and 23 being comparative examples) and Tables 5 to 14.

The halogenated rubber component of the present invention is mixed with the other components by first combining the rubber components and mixed in a Banbury™ blender for 30 seconds at about 90° C., at which time about ¾ of the carbon black is added. Then, after mixing for several minutes and reaching a temperature of about 110° C., all of the remaining ingredients (processing oils, etc.) except for the curing ingredients (ZnO, MBTS and sulfur) are then added and blended. The mixing is then stopped when the temperature reaches about 140° C., and allowed to cool to room temperature. Finally, the curing ingredients are added in a subsequent mixing step and blended in to form the compositions 1-26 of the present invention. Below, Table 4, shows the components used and commercial sources.

TABLE 4
Components and Commercial Sources

| Component | Brief Description | Commercial Source |
|---|---|---|
| Bromobutyl 2222 | Brominated Poly(isobutylene- | ExxonMobil Chemical |
| | co-isoprene), Mooney | Company (Houston, TX) |
| | Viscosity (1 + 8, 125° C.) of | |
| | from 27-37 MU | |
| SBB | Star-branched butyl rubber | ExxonMobil Chemical |
| | 6222 | Company (Houston, TX) |
| EXXPRO ™ 89-4 | 5 wt % PMS, 0.75 mol % | ExxonMobil Chemical |
| | BrPMS, Mooney viscosity of | Company (Houston, TX) |
| | 45 ± 5 MU (1 + 8, 125° C.) | |
| CALSOL ™ 810 | Naphthenic Oil | R. E. Carroll, Inc |
| | ASTM Type 103 | (Trenton, NJ) |
| FLEXON ™ 580 | Naphthenic oil | Imperial Oil |
| | | (Toronto, Canada) |
| ESCOREZ ™ | Aromatic modified aliphatic | ExxonMobil Chemical |
| | resin, 95° C. softening point | Company (Houston, TX) |
| PARAPOL ™ 1300 | Polymer of C₄ raffinate having | ExxonMobil Chemical |
| | and Mn of about 1300 | Company (Houston, TX) |
| | | Infineum, Abingdon, England |
| CLOISITE ™-25A | Dimethylditallowammonium | Southern Clay Products |
| | chloride modified | (Gonzalez, TX) |
| | montmorillonite clay | |
| SP-1068 | Brominated phenol- | Schenectady International |
| | formaldehyde resin | (Schenectady, NY) |
| Struktol 40 MS | Mixture of dark aromatic | Struktol Co. of America |
| | hydrocarbon resins having a | (Stow, OH) |
| | softening point between 50-60° C. | |
| | and a specific gravity | |
| | of 1.02. | |
| Stearic acid | Cure agent | e.g., C. K. Witco Corp. (Taft, |
| | | LA) |
| Sulfur | Cure agent | e.g., R. E. Carroll (Trenton, |
| | | NJ) |
| TMTD | Tetramethylthiuram disulfide | e.g., R. T. Vanderbilt |
| | | (Norwalk, CT) |
| MBTS | 2-mercaptobenzothiazole | R. T. Vanderbilt (Norwalk, |
| | disulfide | CT) or Elastochem (Chardon, |
| | | OH) |
| Maglite-K | Vulcanizer | C. P. Hall (Chicago, IL) |
| KADOX ™ 930 | High Purity French | Zinc Corp. of America |
| Zinc oxide | Process Zinc Oxide | (Monaca, Pa) |
| KADOX ™ 911, | Activators | Zinc Corp. of America |
| KADOX ™ 720-C | | (Monaca, Pa) |
| Zinc Oxide | | |

Compositions 1 and 2 (Table 5) are comparative examples with carbon black and no added polybutene processing oil. N660 has a surface area of 34 m²/gm and a dibutylphthalate oil absorption of 90 cm³/100 gm.

TABLE 5
Example Compositions of Bromobutyl
Rubber without Polybutene Processing Oil

| Component (phr) | 1 | 2 |
|---|---|---|
| Bromobutyl 2222 | 100 | 100 |
| Carbon black, N660 | 60 | 93.4 |
| Stearic acid | 1 | 1 |
| CALSOL ™ 810 oil | 8 | 8 |
| SP-1068 | 4 | 4 |
| STRUKTOL ™ 40MS | 8 | 8 |
| Zinc oxide | 1 | 1 |
| MBTS | 1.25 | 1.25 |
| Sulfur | 0.5 | 0.5 |

Physical property data, Table 6, exemplify the balance that is struck between the air permeability of the compositions and their hardness and modulus values upon increasing carbon black content only. Permeability is desirably reduced. Mooney viscosity, Shore A hardness, and modulus values are increased, which are not desired.

TABLE 6
Example Composition Properties of Bromobutyl
Rubber without Polybutene Processing Oil

| Property | 1 | 2 |
|---|---|---|
| Mooney Scorch @ 135° C., | 16.1 | 13.3 |
| T10 (min) | | |
| Mooney Viscosity @ 100° C., | 54.6 | 82.7 |
| ML(1 + 4) | | |
| Tc50 | 5.4 | 5.1 |
| Tc90 | 10.6 | 9.6 |
| Hardness, Shore A | 44 | 62 |
| 100% Modulus, MPa | 1.0 | 1.9 |
| 300% Modulus, MPa | 3.0 | 5.3 |
| Tensile Strength, MPa | 8.4 | 7.1 |
| Energy to Break | 9.5 | 7.6 |
| Elongation, % | 805 | 600 |
| Air Permeability @ 65° C. | 13.3 | 11.4 |
| cm³-cm/cm²-sec-atm × 10⁸ | | |

Compositions 3-7, Table 7, are further comparative examples with low surface area carbon black and no added polybutene processing oil. Regal 90 has a surface area of 23 m²/gm and a dibutylphthalate oil absorption of 32 cm³/100 gm.

TABLE 7
Example Compositions of Bromobutyl Rubber with Low Surface
Area Carbon Black and without Polybutene Processing Oil

| Component (phr) | 3 | 4 | 5 | 6 | 7 |
|---|---|---|---|---|---|
| Bromobutyl 2222 | 100 | 100 | 100 | 100 | 100 |
| Carbon black, N660 | 60 | 0 | 0 | 0 | 0 |
| Carbon black, Regal 90 | 0 | 60 | 80 | 100 | 120 |
| Stearic acid | 2 | 2 | 2 | 2 | 2 |
| FLEXON ™ 580 oil | 8 | 8 | 8 | 8 | 8 |
| SP-1068 | 4 | 4 | 4 | 4 | 4 |
| STRUKTOL ™ 40MS | 7 | 7 | 7 | 7 | 7 |
| Zinc oxide | 3 | 3 | 3 | 3 | 3 |
| MBTS | 1.5 | 1.5 | 1.5 | 1.5 | 1.5 |
| Sulfur | 0.5 | 0.5 | 0.5 | 0.5 | 0.5 |
| Maglite K | 0.15 | 0.15 | 0.15 | 0.15 | 0.15 |

Physical property data, Table 8, exemplify the balance that is struck between the air permeability of the compositions and their physical properties upon increasing the content of the low surface area carbon black. Permeability is desirably reduced only at very high levels of Regal 90 carbon black, compare 3 to 7. Mooney scorch, tensile strength, and elongation values are decreased, and Shore A hardness is increased, which are not desired.

TABLE 8
Example Composition Properties of Bromobutyl Rubber with Low
Surface Area Carbon Black and without Polybutene Processing Oil

| Property | 3 | 4 | 5 | 6 | 7 |
|---|---|---|---|---|---|
| Mooney Scorch @ | 22 | 19 | 18 | 16 | 16 |
| 135° C., T10 (min) | | | | | |
| Mooney Viscosity @ | 57 | 39 | 42 | 46 | 51 |
| 100° C., ML(1 + 4) | | | | | |
| Tc90 | 33.3 | 34.5 | 33.9 | 32.9 | 34.1 |
| Hardness, Shore A | 51 | 43 | 49 | 55 | 57 |
| 100% Modulus, MPa | 1.1 | 0.7 | 0.9 | 1.0 | 1.2 |
| 300% Modulus, MPa | 3.5 | 1.6 | 2.0 | 2.3 | 3.3 |
| Tensile strength, MPa | 9.2 | 8.7 | 8.5 | 7.9 | 7.0 |
| Elongation, % | 805 | 933 | 843 | 795 | 691 |
| Air Permeability @ | 2.01 | 2.07 | 1.97 | 1.91 | 1.76 |
| 65° C. cm³-cm/ | | | | | |
| cm²-sec-atm × 10⁸ | | | | | |

Compositions 8 and 9, which are duplicate mixes of the same composition, Table 9, are further comparative examples with low surface area carbon black and no added polybutene processing oil. Compositions 10 to 20, Table 9, with a low surface area carbon black and added polybutene processing oil are examples using the invention. Compositions 10 to 20 represent a statistical design of carbon black and processing oil levels. N660 carbon black varies from 60 phr to 0 phr in 20 phr increments, and with Regal 85 carbon black varying from 0 phr to 120 phr in 40 phr increments. Regal 85 has a surface area of 23 m²/gm and a dibutylphthalate oil absorption of 33 cm³/100 gm. Calsol 810 naphthenic processing oil and Parapol 1300 polybutene processing oil both vary from 14 phr to 2 phr in 8 phr increments. Physical property data, Table 10, exemplify the balance that is struck between the air permeability of the compositions and their physical properties upon use of varying levels of the low surface area carbon black, the naphthenic processing oil and the polybutene processing oil. Permeability is desirably reduced relative to compositions 8 and 9 when the polybutene processing oil is present in the compositions as 50% (v/v) or greater of the total processing oil, compositions 14 to 20.

TABLE 9
Example Compositions of Bromobutyl Rubber with Low Surface
Area Carbon Black and Polybutene Processing Oil

| Component (phr) | 8 | 9 | 10 | 11 | 12 | 13 | 14 | 15 | 16 | 17 | 18 | 19 | 20 |
|---|---|---|---|---|---|---|---|---|---|---|---|---|---|
| Bromobutyl 2222 | 100 | 100 | 100 | 100 | 100 | 100 | 100 | 100 | 100 | 100 | 100 | 100 | 100 |
| Carbon Black, N660 | 60 | 60 | 40 | 60 | 20 | 20 | 40 | 40 | 60 | 20 | 40 | 40 | 60 |
| Carbon black, Regal 85 | 0 | 0 | 40 | 80 | 120 | 80 | 80 | 80 | 40 | 40 | 80 | 120 | 120 |
| CALSOL ™ 810 | 8 | 8 | 14 | 14 | 14 | 8 | 8 | 8 | 8 | 2 | 2 | 8 | 2 |
| PARAPOL ™ 1300 | 0 | 0 | 14 | 2 | 8 | 14 | 8 | 8 | 8 | 2 | 8 | 2 | 14 |
| STRUKTOL ™ 40MS | 7 | 7 | 7 | 7 | 7 | 7 | 7 | 7 | 7 | 7 | 7 | 7 | 7 |
| SP-1068 | 4 | 4 | 4 | 4 | 4 | 4 | 4 | 4 | 4 | 4 | 4 | 4 | 4 |
| Stearic Acid | 1 | 1 | 1 | 1 | 1 | 1 | 1 | 1 | 1 | 1 | 1 | 1 | 1 |
| Zinc oxide | 1 | 1 | 1 | 1 | 1 | 1 | 1 | 1 | 1 | 1 | 1 | 1 | 1 |
| MBTS | 1.25 | 1.25 | 1.25 | 1.25 | 1.25 | 1.25 | 1.25 | 1.25 | 1.25 | 1.25 | 1.25 | 1.25 | 1.25 |
| Sulfur | 1.5 | 1.5 | 1.5 | 1.5 | 1.5 | 1.5 | 1.5 | 1.5 | 1.5 | 1.5 | 1.5 | 1.5 | 1.5 |

TABLE 10
Example Composition Properties of Bromobutyl Rubber
with Blends of Carbon Blacks and Processing Oils

| Property | 8 | 9 | 10 | 11 | 12 | 13 | 14 | 15 | 16 | 17 | 18 | 19 | 20 |
|---|---|---|---|---|---|---|---|---|---|---|---|---|---|
| Mooney Scorch, 135° C. | 15.1 | 14.6 | 19.7 | 14.5 | 17.2 | 18.4 | 16.0 | 16.5 | 16.7 | 16.1 | 15.0 | 16.8 | 12.8 |
| T10 (min) | | | | | | | | | | | | | |
| Mooney Viscosity, @ | 57.9 | 57.6 | 32.3 | 68.2 | 46.4 | 38.5 | 56.9 | 57.4 | 56.8 | 51.5 | 66.9 | 88 | 35.9 |
| 100° C. ML(1 + 4) | | | | | | | | | | | | | |
| Tc50 | 4.1 | 4.0 | 4.7 | 4.5 | 4.8 | 4.6 | 4.5 | 4.7 | 4.3 | 4.5 | 4.5 | 4.3 | 4.3 |
| Tc90 | 8.7 | 8.7 | 8.6 | 8.7 | 9.0 | 8.6 | 8.9 | 9.0 | 8.2 | 10.1 | 8.9 | 8.8 | 8.2 |
| Hardness, Shore A | 46.7 | 45.9 | 36.5 | 62.7 | 50.7 | 40.7 | 53.5 | 53.9 | 52.3 | 43.5 | 59.7 | 69.1 | 72.9 |
| 100% Modulus, MPa | 1.14 | 1.17 | 0.69 | 2.00 | 1.22 | 0.81 | 1.43 | 1.45 | 1.34 | 0.91 | 1.75 | 2.56 | 3.19 |
| 300% Modulus, MPa | 3.68 | 3.71 | 1.96 | 5.98 | 3.74 | 2.48 | 4.49 | 4.54 | 4.26 | 2.63 | 5.45 | 6.44 | 7.05 |
| Tensile strength, MPa | 9.2 | 8.7 | 8.1 | 7.0 | 6.5 | 8.0 | 7.5 | 7.4 | 8.0 | 11.9 | 7.8 | 6.7 | 7.4 |
| Elongation, % | 836 | 865 | 924 | 513 | 641 | 845 | 669 | 650 | 710 | 921 | 658 | 403 | 351 |
| Energy to Break, N/mm | 12.0 | 12.5 | 8.7 | 7.5 | 17.4 | 9.6 | 9.9 | 9.5 | 9.2 | 14.2 | 9.6 | 5.3 | 5.8 |
| Adhesion to NR @ | 22.3 | 17.5 | 13.7 | 9.7 | 13.1 | 16.5 | 13.8 | 13.8 | 17.2 | 16.2 | 17.9 | 3.9 | 5.4 |
| 22° C., N/mm | | | | | | | | | | | | | |
| Oxygen Permeability @ | 28.2 | 27.5 | 33.5 | 26.8 | 28.4 | 27.3 | 25.2 | 26.1 | 24.8 | 22.8 | 20.1 | 18.2 | 17.2 |
| 60° C. cc-mil/ | | | | | | | | | | | | | |
| m²-day-mm Hg | | | | | | | | | | | | | |

Compositions 21 and 22, Table 11, which are duplicate mixes of the same composition, with a low surface area carbon black and only a polybutene processing oil present is a further example of the invention.

TABLE 11
Example Compositions of Bromobutyl Rubber with Low Surface
Area Carbon Black and Polybutene Processing Oil

| Component (phr) | 8 | 9 | 21 | 22 |
|---|---|---|---|---|
| Bromobutyl 2222 | 100 | 100 | 100 | 100 |
| Carbon black N660 | 60 | 60 | 0 | 0 |
| Carbon black, Regal 85 | 0 | 0 | 100 | 100 |
| Stearic acid | 1 | 1 | 1 | 1 |
| CALSOL ™ 810 oil | 8 | 8 | 0 | 0 |
| PARAPOL ™ 1300 | 0 | 0 | 8 | 8 |
| SP-1068 | 4 | 4 | 4 | 4 |
| STRUKTOL ™ 40MS | 7 | 7 | 7 | 7 |
| Zinc oxide | 1 | 1 | 1 | 1 |
| MBTS | 1.25 | 1.25 | 1.25 | 1.25 |
| Sulfur | 1.5 | 1.5 | 1.5 | 1.5 |

Physical property data, Table 12, exemplify the balance that is struck between the air permeability of the compositions and their physical properties upon use of high levels of the low surface area carbon black and the polybutene processing oil. Permeability is desirably reduced and physical properties are not affected, compare 8 and 9, to 21 and 22, both sets are duplicate mixes of the same composition.

TABLE 12
Example Composition Properties of Bromobutyl Rubber with Low
Surface Area Carbon Black and Polybutene Processing Oil

| Property | 8 | 9 | 21 | 22 |
|---|---|---|---|---|
| Mooney Scorch @ 135° C., | 15.1 | 14.6 | 15.7 | 15.7 |
| T10 (min) | | | | |
| Mooney Viscosity @ 100° C., | 57.9 | 57.6 | 53.7 | 54.9 |
| ML(1 + 4) | | | | |
| Tc50 | 4.1 | 4.0 | 4.1 | 4.0 |
| Tc90 | 8.7 | 8.7 | 8.9 | 8.9 |
| Hardness, Shore A | 46.7 | 45.9 | 47.7 | 48.5 |
| 100% Modulus, MPa | 1.14 | 1.17 | 1.19 | 1.14 |
| 300% Modulus, MPa | 3.68 | 3.71 | 3.59 | 3.39 |
| Tensile strength, MPa | 9.2 | 8.7 | 8.5 | 7.9 |
| Elongation, % | 836 | 865 | 776 | 804 |
| Energy to Break, N/mm | 12.0 | 12.5 | 11.2 | 11.8 |
| Adhesion to NR @22° C., | 22.3 | 17.5 | 20.6 | 20.3 |
| N/mm | | | | |
| Oxygen Permeability @ | 28.2 | 27.5 | 19.8 | 20.8 |
| 60° C. cc-mil/m²- | | | | |
| day-mm Hg | | | | |

Compositions 24-26, Table 13, with a low surface area carbon black, clay and polybutene processing oil present is a further example of the invention.

TABLE 13
Example Compositions of Bromobutyl Rubber with Low Surface
Area Carbon Black, Clay and Polybutene Processing Oil

| Component (phr) | 23 | 24 | 25 | 26 |
|---|---|---|---|---|
| SBB 6222 | 100 | 100 | 100 | 100 |
| Carbon black, N660 | 60 | 0 | 0 | 0 |
| Carbon black, N990 | 0 | 100 | 100 | 100 |
| Closite 25A | 0 | 5 | 10 | 15 |
| Stearic acid | 2 | 2 | 2 | 2 |
| CALSOL ™ 810 oil | 8 | 0 | 0 | 0 |
| PARAPOL ™ 2400 | 0 | 10 | 10 | 10 |
| SP-1068 | 4 | 4 | 4 | 4 |
| STRUKTOL ™ 40MS | 7 | 7 | 7 | 7 |
| Zinc oxide | 3 | 3 | 3 | 3 |
| MBTS | 1.5 | 1.5 | 1.5 | 1.5 |
| Maglite K | 0.15 | 0.15 | 0.15 | 0.15 |
| Sulfur | 0.5 | 0.5 | 0.5 | 0.5 |

PARAPOL™ 2400 is a polymer of a C4 raffinate having an Mn of about 2400.

Physical property data, Table 14, exemplify the balance that is struck between the air permeability of the compositions and their physical properties upon use of high levels of the low surface area carbon black, clay and the polybutene processing oil. Permeability is desirably reduced and physical properties are not affected, compare 23 to 24-26.

TABLE 14
Example Composition Properties of Bromobutyl Rubber with Low
Surface Area Carbon Black, Clay and Polybutene Processing Oil

| Property | 23 | 24 | 25 | 26 |
|---|---|---|---|---|
| Mooney Scorch @ 135° C., | 33.2 | 32.8 | 34.8 | 36.1 |
| T10, min. | | | | |
| Mooney Viscosity @ 100° C., | 55.3 | 43.9 | 44.0 | 45.8 |
| ML(1 + 4) | | | | |
| Tc50, min. | 10.8 | 12.9 | 14.0 | 13.7 |
| Tc90, min. | 27.0 | 22.7 | 24.9 | 25.5 |
| Hardness, Shore A | 61 | 59 | 60 | 63 |
| 100% Modulus, MPa | 1.45 | 1.36 | 1.38 | 1.48 |
| 300% Modulus, MPa | 4.10 | 3.22 | 3.21 | 3.33 |
| Tensile Strength, MPa | 9.3 | 7.6 | 8.3 | 8.2 |
| Elongation, % | 751 | 756 | 781 | 757 |
| Die C Tear Energy, N/mm | 54.9 | 43.9 | 44.9 | 48.5 |
| Adhesion to SBR/NR @22° C., | 6.1 | 8.5 | 6.0 | 2.4 |
| N/mm | | | | |
| Adhesion to NR @22° C., | 30.0 | 16.6 | 11.6 | 7.4 |
| N/mm | | | | |
| Oxygen Permeability @ 60° C. | 28.4 | 19.6 | 18.4 | 18.0 |
| cc-mil/m²-day-mm Hg | | | | |

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

1. A composition comprising:
1) an elastomer comprising at least 30 mol % of isobutylene;
2) carbon black having a surface area of less than 30 m²/g and a dibutylphthalate oil absorption of less than 80 cm³/100 gm; and
3) polybutene oil having a number average molecular weight greater than 400.

2. The composition of claim 1 where:
1) the elastomer comprises at least 40 mol % of isobutylene;
2) the carbon black has a surface area of less than 25 m²/g and a dibutylphthalate oil absorption of less than 75 cm³/100 gm; and
3) polybutene oil has a number average molecular weight greater than 400.

3. The composition of claim 1 where:
1) the elastomer comprises at least 50 mol % of isobutylene;
2) the carbon black has a surface area of less than 25 m²/g and a dibutylphthalate oil absorption of less than 75 cm³/100 gm; and
3) polybutene oil has a number average molecular weight between 400 and 15,000.

4. The composition of claim 1 where:
1) the elastomer comprises at least 50 mol % of isobutylene;
2) the carbon black has a surface area of less than 25 m²/g and a dibutylphthalate oil absorption of less than 75 cm³/100 gm; and
3) polybutene oil has a number average molecular weight between 700 and 8,000.

5. The composition of claim 1 where the elastomer is present at 20 to 100 phr, the carbon black is present at 10 to 200 phr and the polybutene oil is present at 2 to 40 phr.

6. The composition of claim 1 where the elastomer is present at 20 to 100 phr, the carbon black is present at 20 to 180 phr and the polybutene oil is present at 2 to 30 phr.

7. The composition of claim 1, wherein the elastomer is selected from a halogenated poly(isobutylene-co-alkylstyrene), halogenated star-branched butyl rubber, halogenated butyl rubber, butyl rubber, and mixtures thereof.

8. The composition of claim 1, also comprising a thermoplastic polymer.

9. The composition of claim 1, wherein the polybutene has a number average molecular weight between 400 and 10,000.

10. The composition of claim 1, wherein the polybutene is present from 2 to 40 phr.

11. The composition of claim 1, further comprising one or more filler components selected from calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm.

12. The composition of claim 1, wherein the composition also includes an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof.

13. An innerliner for a tire comprising the composition of claim 1.

14. An innertube for a tire comprising the composition of claim 1.

15. The composition of claim 1 further comprising one or more carbon blacks having a surface area of greater than 30 m²/g and/or a dibutylphthalate oil absorption of greater than 80 cm³/100 gm.

16. The composition of claim 1 where the elastomer comprises star branched butyl rubber.

17. The composition of claim 1 where the elastomer comprises halogenated butyl rubber.

18. The composition of claim 1 further comprising naphthenic processing oil.

19. The composition of claim 1 where the polybutene oil comprises a copolymer of butene derived units and one or more olefin derived units having from 3 to 8 carbon atoms.

20. The composition of claim 1 where the polybutene oil comprises a homopolymer or copolymer of a C₄ raffinate.

21. The composition of claim 1 where the polybutene oil comprises a homopolymer of isobutylene, or a copolymer of isobutylene and 1-butene or 2-butene, or a terpolymer of isobutylene and 1-butene and 2-butene, wherein the isobutylene derived units are from 40 to 100 wt % of the copolymer, the 1-butene derived units are from 0 to 40 wt % of the copolymer, and the 2-butene derived units are from 0 to 40 wt % of the copolymer.

22. The composition of claim 1 where the polybutene oil has a viscosity of from 10 to 6000 cSt at 100° C.

23. The composition of claim 1 where the polybutene oil has a viscosity of from 35 to 5000 cSt at 100° C.

24. An air barrier comprising the composition of claim 1.

25. The composition of claim 1 further comprising an engineering resin selected from the group consisting of polyamides, polycarbonates, polyesters, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK) and mixtures thereof.

26. A dynamically vulcanized alloy comprising the composition of claim 1 and a polyamide.

27. A composition comprising at least one poly(isobutylene-co-alkylstyrene), carbon black having a surface area of less than 30 m²/g and a dibutylphthalate oil absorption of less than 80 cm³/100 gm; and
polybutene oil having a number average molecular weight greater than 400.

28. The composition of claim 27, wherein the poly(isobutylene-co-alkylstyrene) is a halogenated poly(isobutylene-co-p-methylstyrene).

29. The composition of claim 27, wherein the poly(isobutylene-co-alkylstyrene) is a halogenated poly(isobutylene-co-p-methylstyrene) having a p-bromomethylstyrene content of from 0.1 to 5 wt % based on the weight of the copolymer.

30. The composition of claim 27, also comprising a thermoplastic polymer.

31. The composition of claim 27, wherein the polybutene has a number average molecular weight of from 400 to than 10,000.

32. The composition of claim 27, wherein the polybutene is present from 2 to 40 phr.

33. The composition of claim 27, further comprising filler selected from calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm.

34. The composition of claim 27, wherein the composition also includes an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof.

35. The composition of claim 27 further comprising an engineering resin selected from the group consisting of polyamides, polycarbonates, polyesters, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK) and mixtures thereof.

36. A dynamically vulcanized alloy comprising the composition of claim 27 and a polyamide.

37. A dynamically vulcanized alloy comprising the composition of claim 27 and an engineering resin.

38. An innerliner for a tire comprising the composition of claim 27.

39. An innertube for a tire comprising the composition of claim 27.

40. An air barrier comprising the composition of claim 27.

41. The composition of claim 1, wherein the polybutene has a viscosity of from 10 to 6000 cSt at 100° C.

42. The composition of claim 1, wherein the polybutene is present from 2 to 30 phr.

43. The composition of claim 1, wherein naphthenic oil is substantially absent.

44. A dynamically vulcanized alloy comprising the composition of claim 1 and a polyamide.

45. A dynamically vulcanized alloy comprising the composition of claim 1 and an engineering resin.

46. A composition comprising an elastomer comprising at least 40 mol % isobutylene, carbon black having a surface area of less than 30 m²/g and a dibutylphthalate oil absorption of less than 80 cm³/100 gm; at least one exfoliated clay, and polybutene oil having a number average molecular weight greater than 400.

47. The composition of claim 46, wherein the copolymer is selected from a halogenated poly(isobutylene-co-alkylstyrene), halogenated star-branched butyl rubber, halogenated butyl rubber, butyl rubber, and mixtures thereof.

48. The composition of claim 46, also comprising a thermoplastic polymer.

49. The composition of claim 46, wherein the polybutene has a number average molecular weight between 400 and 10,000.

50. The composition of claim 46, wherein the polybutene is present from 2 to 40 phr.

51. The composition of claim 46, further comprising filler selected from calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm.

52. The composition of claim 46, wherein the exfoliated clay is selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof.

53. An innerliner for a tire comprising the composition of claim 46.

54. An innertube for a tire comprising the composition of claim 46.

55. The composition of claim 46, wherein the polybutene has a viscosity of from 10 to 6000 cSt at 100° C.

56. The composition of claim 46, wherein the polybutene has a viscosity of from 35 to 5000 cSt at 100° C.

57. The composition of claim 46, wherein naphthenic oil is substantially absent.

58. An air barrier made by the method of combining: 1) at least one elastomer comprising at least 40 mol % isobutylene, carbon black having a surface area of less than 30 m²/g and a dibutylphthalate oil absorption of less than 80 cm³/100 gm; polybutene oil having a number average molecular weight greater than 400, and at least one cure agent; and 2) curing the combined components.

59. The air barrier of claim 58, wherein the copolymer is selected from a halogenated poly(isobutylene-co-alkylstyrene), halogenated star-branched butyl rubber, halogenated butyl rubber, butyl rubber, and mixtures thereof.

60. The air barrier of claim 58, also comprising a thermoplastic resin.

61. The air barrier of claim 58, wherein the polybutene has a number average molecular weight of from 400 to 10,000.

62. The air barrier of claim 58, wherein the polybutene is present from 2 to 40 phr.

63. The air barrier of claim 58, further comprising filler selected from calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm.

64. The air barrier of claim 58, wherein the composition also includes an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof.

65. The air barrier of claim 58, wherein the polybutene has a viscosity of from 35 to 5000 cSt at 100° C.

66. The air barrier of claim 58, wherein naphthenic oil is substantially absent.

67. The air barrier of claim 58, wherein the air permeability of the barrier is from 1.2×10⁻⁸ to 4×10⁻⁸ cm³-cm/cm²-sec-atm at 65° C.

68. The air barrier of claim 58, wherein the polybutene processing oil is a copolymer of isobutylene derived units and 1-butene derived units.

69. The air barrier of claim 58, also comprising a secondary elastomer selected from natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; isobutylene/alkylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.

70. A method to prepare a composition comprising: combining:
1) an elastomer comprising at least 30 mol % of isobutylene;
2) carbon black having a surface area of less than 30 m²/g and a dibutylphthalate oil absorption of less than 80 cm³/100 gm; and
3) polybutene oil having a number average molecular weight greater than 400.

71. A method to prepare a barrier comprising:
a) combining:
1) an elastomer comprising at least 30 mol % of isobutylene;
2) carbon black having a surface area of less than 30 m²/g and a dibutylphthalate oil absorption of less than 80 cm³/100 gm;
3) polybutene oil having a number average molecular weight greater than 400;
4) a curing agent, and
b) curing the composition.

72. A method to prepare a barrier comprising:
a) combining:
1) an elastomer comprising at least 30 mol % of isobutylene;
2) carbon black having a surface area of less than 30 m²/g and a dibutylphthalate oil absorption of less than 80 cm³/100 gm;
3) polybutene oil having a number average molecular weight greater than 400;
4) optionally, a second elastomer selected from natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; isobutylene/alkylstyrene copolymers such as isobutylene/meta-bromomethylstyrene, isobutylene/bromomethylstyrene, isobutylene/chloromethylstyrene, halogenated isobutylene cyclopentadiene, and isobutylene/chloromethylstyrene and mixtures thereof.
5) filler selected from the group consisting of calcium carbonate, clay, mica, silica and silicates, talc, titanium dioxide, starch, wood flower, carbon black having a surface area greater than 30 m²/gm, carbon black having a dibutylphthalate oil absorption of more than 80 cm³/100 gm, and carbon black having a surface area of more than 30 m²/g and a dibutylphthalate oil absorption of more than 80 cm³/100 gm;
6) optionally, an exfoliated clay selected from exfoliated natural or synthetic montmorillonite, nontronite, beidellite, volkonskoite, laponite, hectorite, saponite, sauconite, magadite, kenyaite, stevensite, vermiculite, halloysite, aluminate oxides, hydrotalcite, and mixtures thereof;
7) optionally, a thermoplastic resin; and
8) a curing agent, and
b) curing the composition.

73. The method of claim 72, wherein the copolymer is selected from a halogenated poly(isobutylene-co-alkylstyrene), halogenated star-branched butyl rubber, halogenated butyl rubber, butyl rubber, and mixtures thereof.

74. The method of claim 72 wherein the thermoplastic polymer comprises an engineering resin.

75. The composition of claim 1 further comprising paraffinic oil.

76. An air barrier comprising the composition of claim 46.

77. The composition of claim 1, wherein paraffinic oil is substantially absent.

78. The composition of claim 46, wherein paraffinic oil is substantially absent.

79. The composition of claim 58, wherein paraffinic oil is substantially absent.

80. The composition of claim 1, wherein naphthenic, aliphatic, paraffinic and other aromatic resins and oils are substantially absent.
